(19) United States
(12) Patent Application Publication
(10) Pub. No.: US 2020/0409452 A1
(43) Pub. Date: Dec. 31, 2020

(54) SYSTEMS AND METHODS FOR PERFORMING INSPECTIONS WITH A HEAD-WORN DISPLAY DEVICE

(71) Applicant: BP Corporation North America Inc., Houston, TX (US)

(72) Inventors: Khoa Nguyen, Katy, TX (US); Max C. Lyoen, Houston, TX (US); Minh Giang, Richmond, TX (US)

(73) Assignee: BP Corporation North America Inc., Houston, TX (US)

(21) Appl. No.: 16/907,764

(22) Filed: Jun. 22, 2020

Related U.S. Application Data
(60) Provisional application No. 62/868,607, filed on Jun. 28, 2019.

(51) Int. Cl. G06F 3/01; G02B 27/01; G06T 19/20; G06T 19/00; G06Q 10/00

(52) U.S. Cl. CPC G06F 3/011; G06F 3/017; G06Q 10/20; G06T 19/20; G06T 19/006; G02B 27/0172

(57) ABSTRACT

A method for performing an inspection includes (a) concurrently viewing a real object through a display screen of a head-worn display device worn by a user and a virtual object projected on the display screen of the head-worn display device. In addition, the method includes (b) comparing the virtual object to the real object. Further, the method includes (c) generating an inspection result in response to the comparison in (b).

### CROSS-REFERENCE TO RELATED APPLICATIONS

This application claims benefit of U.S. provisional patent application Ser. No. 62/868,607 filed Jun. 28, 2019, and entitled “Systems and Methods for Performing Inspections with a Head-Worn Display Device,” which is hereby incorporated herein by reference in its entirety.

### STATEMENT REGARDING FEDERALLY SPONSORED RESEARCH OR DEVELOPMENT

Not applicable.

### BACKGROUND

Offshore drilling and production operations are expensive and complex endeavors. Due to limited access to offshore operations, limited space on offshore structures, and extreme conditions in offshore environments, the design, construction, and maintenance of the equipment employed in offshore operations present numerous challenges. For example, production delays may occur due to drilling equipment deemed unapproved during a final inspection. These incessant challenges are proactively managed by the production companies (e.g., owners) optimizing the quality, lifecycle, value, and integrity of their drilling assets. Typically, quality management systems and related processes are supervised and implemented by an experienced team of engineers, quality experts, and inspectors to identify and mitigate potential issues in the construction and maintenance of offshore equipment.

### SUMMARY

Embodiments of methods for performing inspections are disclosed herein. In accordance with at least one example of the disclosure, a method for performing an inspection comprises concurrently viewing a real object through a display screen of a head-worn display device worn by a user and a virtual object projected on the display screen of the head-worn display device. The method further comprises comparing the virtual object to the real object; and generating an inspection result in response to the comparison.

Embodiments of methods for performing quality control inspections are disclosed herein. In accordance with another example of the disclosure, a method for performing a quality control inspection comprises concurrently viewing a real object through a display screen of a head-worn display device worn by a user and a virtual object displayed on the display screen, wherein the virtual object is a virtual representation of the real object. The method further comprises overlaying the virtual object over the real object in response to a first-hand gesture performed by the user; inspecting the real object while the virtual object is overlaying the real object.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various examples, reference will now be made to the accompanying drawings in which:

FIG. 1 is a partial schematic and a partial pictorial view of an embodiment of a virtual inspection system in accordance with principles described herein;

FIG. 2 is a flowchart illustrating an embodiment of a method for performing an inspection with the system of FIG. 1;

FIGS. 3A-3F are perspective views of exemplary inspections performed with the system of FIG. 1 in accordance with the method of FIG. 2;

FIG. 4 is a flowchart illustrating an embodiment of a method for performing an inspection with the system of FIG. 1; and

FIGS. 5A and 5B are perspective views of exemplary inspections performed with the system of FIG. 1 in accordance with the method of FIG. 4.

### DETAILED DESCRIPTION

This disclosure is directed to systems and methods for manufacturing, assembling, transporting, and installing equipment (e.g., drilling equipment). Generally, different sections and portions of drilling equipment, such as a methanol injection skid, may be machined independently and then assembled together in an assembly unit. In some cases, due to unintended machining errors, select features of one or more of the discrete portions and sections may not match the as-designed dimensional requirements noted in a specification manual of the drilling equipment. In such cases, the improper pieces may not come together (or line up) as planned, and thus, may cause production delays. To prevent such situations, the production company may employ a quality management team to oversee adherence to quality plans by placing inspectors at one or more critical locations along the equipment manufacturing chain. These inspectors inspect various features (e.g., dimensions) of the pieces against the design specifications.

Some features, such as the model or serial number of a motor or equivalent catalogue item, are verified visually. The model or serial number can also be used to lookup the operating envelope (i.e., the safe operating conditions) of the component as defined by the manufacturer of the component (e.g., the minimum and maximum operating pressure of the component). The operating envelope can then be compared to the design envelope (i.e., the operating conditions the component is expected to experience) to ensure it falls within and complies with the operating envelope defined by the manufacturer. For example, a gasket model number will have an associated maximum pressure rating defined by the manufacturer of the gasket. If the anticipated operating conditions of the gasket exceed the maximum pressure rating of the gasket, there is a risk the gasket may undesirably fail. Thus, comparison of the operating envelope of a component, which can be looked up via the model or serial number, to the anticipated operating conditions can be used as a form of quality inspection. If the anticipated operating conditions fall within the operating envelope, the component is suitable, whereas if the anticipated operating conditions fall outside the operating envelope, the component may need to be changed. Other features, such as dimensions or location in space (e.g., on a Cartesian coordinate system) against a reference point on the equipment, are checked manually using measuring tapes. However, even such inspection and verification processes are prone to human errors, and thus, new techniques and methods are needed to reduce inspection-related errors and avoid, or at least minimize, production delays. To improve quality management inspection accuracy and to reduce errors, embodiments of quality inspection systems and methods described herein are aided by virtual reality technology.

Accordingly, this disclosure describes systems and methods for performing quality inspections. In particular, the instant disclosure describes systems and methods for performing inspections in a mixed-reality environment, which offers the potential to reduce human error, as well as improve the efficiency and accuracy of the inspection process, for example, by ensuring that the latest design requirements are used and compared to the actual features of a component without delay. In some embodiments, the mixed-reality environment is enabled by a head-worn optical see-through display device that allows simultaneous, concurrent views—to a user (e.g., quality control inspector) wearing the device—of both the real object being inspected and a virtual object, which may be a virtual representation of the real object.

As used herein, the term “real object,” refers to an actual, physical object (equipment or portions/parts thereof) being inspected (e.g., drilling equipment); and the term “virtual object” and “virtual copy” refer to a three-dimensional (3D), digitally produced representation (e.g., image) of a real object, which may be a virtual representation of the real object being inspected or a virtual representation of a real object that is associated with or coupled to a real object being inspected. The virtual object is presented to the user in a manner in which the object seems to be, or may be perceived as, real. In general, a virtual object may be derived from a model of the real object it represents (e.g., a three dimensional computer aided design model).

In some embodiments described herein, the virtual objects are presented to a user via a head-worn display device in which the user wearing the display device is able to see through a transparent (or semi-transparent) element of the display device. The user can directly view the real objects through the transparent element. The transparent element may also be referred to herein as a “combiner” as it is configured to superimpose or overlay light projected from the display device onto the user's view of the real world. In particular, the light from the display device projects an image of a virtual object over the see-through view of real object(s) such that the features of both the real and virtual objects can be viewed simultaneously. In general, the virtual object may be a virtual representation of the real object (i.e., the virtual object corresponds to the real object) or the virtual object may be a virtual representation of an object that is different from the real object. In general, a virtual object is a 3D model exhibiting the “as designed” specifications (e.g., components, dimensions, etc.). A virtual object can be saved and accessed from a local database where an inspection is being performed, or saved and accessed from a remote database disposed at a remote location relative to the location where an inspection is being performed.

At least in some examples, a user wearing the head-worn display device views a virtual object on the display device and can walk around an area where the virtual object appears. In some embodiments, the virtual object can be viewed for each viewpoint of multiple viewpoints, giving the user the perception that they are walking around an object that occupies real space. In some embodiments, virtual objects can be overlaid on corresponding real objects, which can provide an increased sense of immersion in the immersed quality inspection. In such examples, if the user's head pose changes to view different overlaid virtual objects, the head-worn display device matches the user's dynamically changing head pose to provide a complete view. The immersive inspection experience and the functions that are associated with the immersive inspection experience assist quality management personnel during inspections by providing immediate access to information relating to the design of the real object to compare to the information associated to the real object without delay. Examples of some of the functions associated with the immersive inspection experience are described in more detail below.

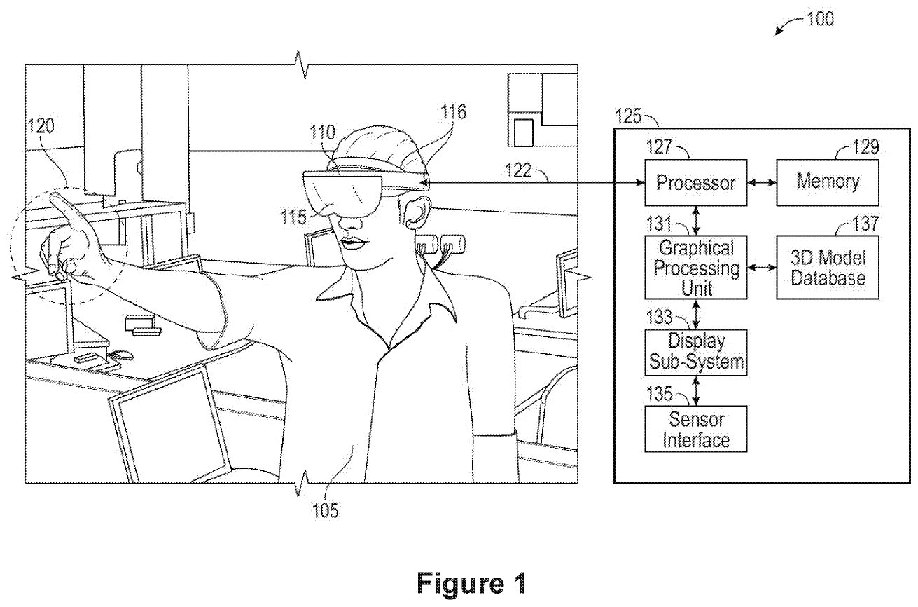

Refer now to FIG. 1, an embodiment of a system 100 for performing an immersed quality inspection is shown. In this embodiment, system 100 includes a head-worn display device 110 that enables the immersive inspection experience for a user 105 and a control system 125 communicatively coupled to the head-worn display device 110 via a communication link 122. The head-worn display device 110, in one example, is a mixed-reality device that concurrently allows viewing of both real objects and generated virtual objects for the user 105 to see through the head-worn display device 110. More specifically, the user 105 perceives that they “see” both the virtual objects positioned in the real world and the real objects positioned in the real world despite the fact that the virtual objects do not exist in the real world. The user 105, in one example, is a quality control inspector who is to perform a quality control inspection.

The head-worn display device 110 is worn by the user 105 with the help of a frame structure 116 disposed about the head of the user 105. The head-worn display device 110 includes a display system 115 mounted on the frame structure 116 and positioned over the front of the eyes of the user 105 and across the field of view of the user 105. In some examples, a speaker (not shown in FIG. 1) is incorporated into or coupled to the head-worn display device 110. The speaker, if incorporated into the head-worn display device 110, may be positioned proximal to an ear canal of the user 105, for instance, like an earbud or a headphone. The head-worn display device 110 also includes one or more sensors (not shown in FIG. 1) for detecting the head pose of the user 105 and gestures made by the user 105. In general, the head pose of the user 105 includes the position, orientation, and movement of the head of the user 105. In some examples, the sensors also detect the eye position of the user 105. Sensors, in one example, include gyros, accelerometers, inertial sensors, global positioning system (GPS) sensors, camera sensors, gesture sensors, etc. The gesture sensors detect and recognize gestures made by the user 105 and cause a function corresponding to and in response to the gestures to be performed.

FIG. 1 depicts an illustrative gesture 120 performed by the user 105. The gesture 120 made by the user 105 changes the position of a virtual object in one example. As the user performs the gesture 120—which in one example is a hand movement—the virtual object tracks the hand's movement, and the user 105 can view, through the head-worn display device 110, the virtual object's movement from a first position to a second position in response to the gesture 120. In some examples, the user 105 can make adjustments to the transparency of the virtual objects in order to differentiate and distinguish between the real object(s) and virtual object(s).

The head-worn display device 110 is linked via the communication link 122 to the control system 125. In general, the communication link 122 can be wired or wireless. The control system 125 implements at least some of the functions that allow the head-worn display device 110 to concurrently display both real object(s) and virtual objects. In this embodiment, the control system 125 includes a processor 127, a memory 129, a graphical processing unit (GPU) 131, a display sub-system 133, and a sensor interface 135. The control system 125, in various examples, may be a desktop computer system or a handheld device, such as a smartphone. While, in some examples, the control system 125 is a standalone device, in other examples, the control system 125 is coupled to other machines in a network. In a network deployment, the control system 125 operates as a server machine or a client machine in a server-client environment, or as a peer machine in a peer-to-peer environment. In other words—in some examples, the control system 125 includes or corresponds to a server computer, a client computer, a personal computer (PC), a tablet computer, a laptop computer, a netbook, a mobile device, or any machine capable of executing, sequentially or otherwise, machine-readable instructions stored in the memory 129. The machine-readable instructions stored in the memory 129 specify actions to be taken by the processor 127.

In some examples, the processor 127 includes one or more microprocessors or digital signal processors (DSPs). In addition, or alternatively, to the microprocessors or DSPs, the processor 127 may include one or more application specific integrated circuits (ASICs) or field programmable gate arrays (FPGAs). The processor 127 is configured to generate virtual objects using 3D-accelerator-based graphics cards or special purpose graphics machines such as SILICON GRAPHICS® workstations. In general, memory 129 may include random access memory (RAM), read-only memory (ROM), removable disk memory, flash memory, or a combination of these types of memories. The memory 129 may, at least in part, be used as cache (or buffer) memory, and typically includes an operating system (OS), which may be one of current or future commercially available operating systems such as, but not limited to, LINUX®, Real-Time Operating System (RTOS), etc. The sensor interface 135 receives information from the sensors placed in the head-worn display device 110. The display system 115 includes a display sub-system 133 and a partially transparent display screen (not shown in FIG. 1) through which the display sub-system 133 projects images that are perceived as augmentations to the real-world environment. In one example, the head-worn display device 110 could include any head-word display device configured to concurrently display real and virtual objects. For instance, Microsoft HOLOLENS®; Magic Leap MAGIC LEAP ONE®.

The control system 125 also includes a 3D model database 137, which contains 3D models of the equipment to be inspected. The 3D models of the equipment (or portions thereof) may be supplied by the vendors supplying the equipment. For example, the 3D models may include 3D models of the drilling rig facility, generators, chemical injection skid, turbine, heaters, separators, manifolds, trees, jumpers, risers, and umbilical termination assembly, etc. The 3D models of the equipment may be transformed into their respective virtual objects using relevant computer graphics language processed by the GPU 131. In some examples, the memory 129 may store data relevant to the real objects such that the user 105 can access this data through the head-worn display device 110, for instance, by using the gesture 120. For example, the operator may access specification reports, schematics, and reliability reports of a real object without delay, which can provide the most current design data for use in inspecting and accepting the components or equipment being inspected. The head-worn display device 110 also provides access to a work control system (not shown in FIG. 1) where the user can highlight, mark, and notify any issues that are identified during inspection. Any perceived issues or discrepancies saved in the work control system can be pulled from the control system during subsequent construction, repair, or maintenance to be addressed.

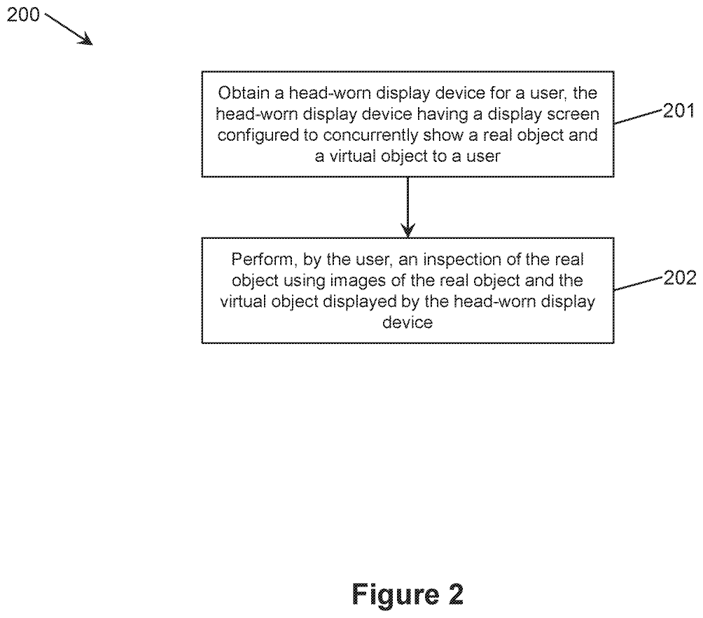

Referring now to FIG. 2, an embodiment of a method 200 for performing an inspection with the system 100 is shown. In this embodiment, the method 200 begins with block 201 that includes obtaining a head-worn display device, such as the head-worn display device 110 to be worn by the user 105. The display system 115 of the head-worn display device 110 has a display screen that concurrently displays real object(s) and virtual object(s) to the user 105. Next, in block 202, the user 105 performs an inspection (e.g., a quality control inspection) of the real object using the head-worn display device 110 and the images of the real object(s) and the virtual object(s) displayed by the head-worn display device 110. Examples of some of the quality control inspections that may be performed according to method 200 by the user 105 using the head-worn display device 110 are described herein. The scope of this disclosure, however, is not limited to the exemplary inspections described herein, and other inspections may be performed via block 202 using the system 100.

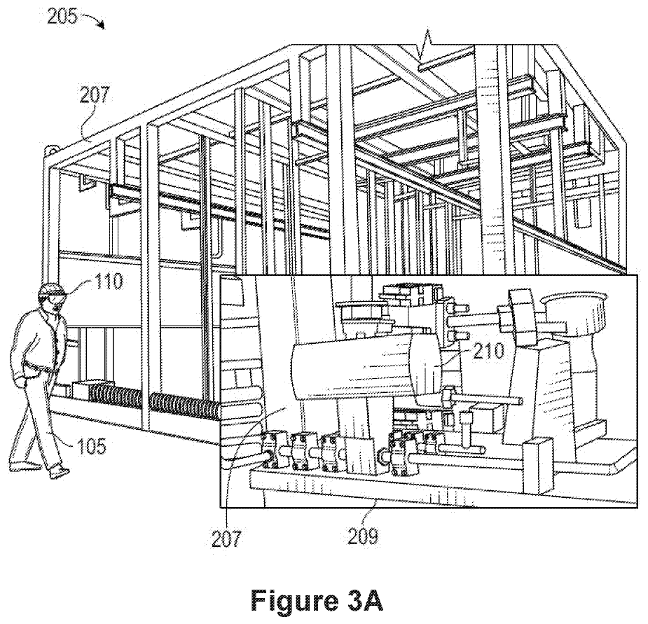

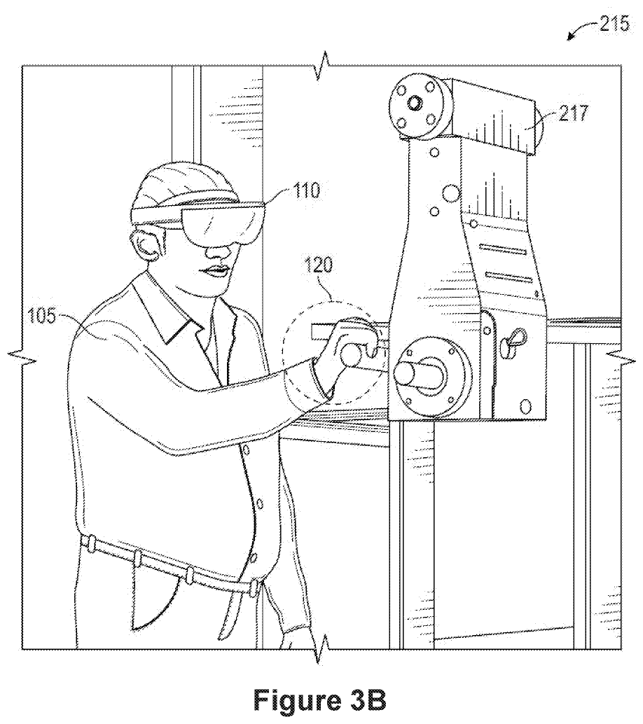

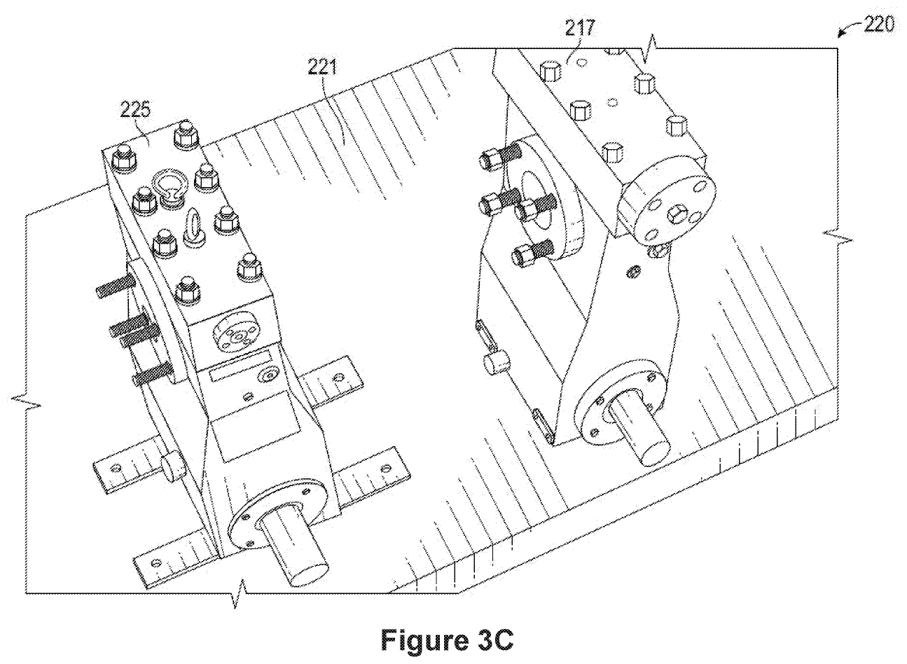

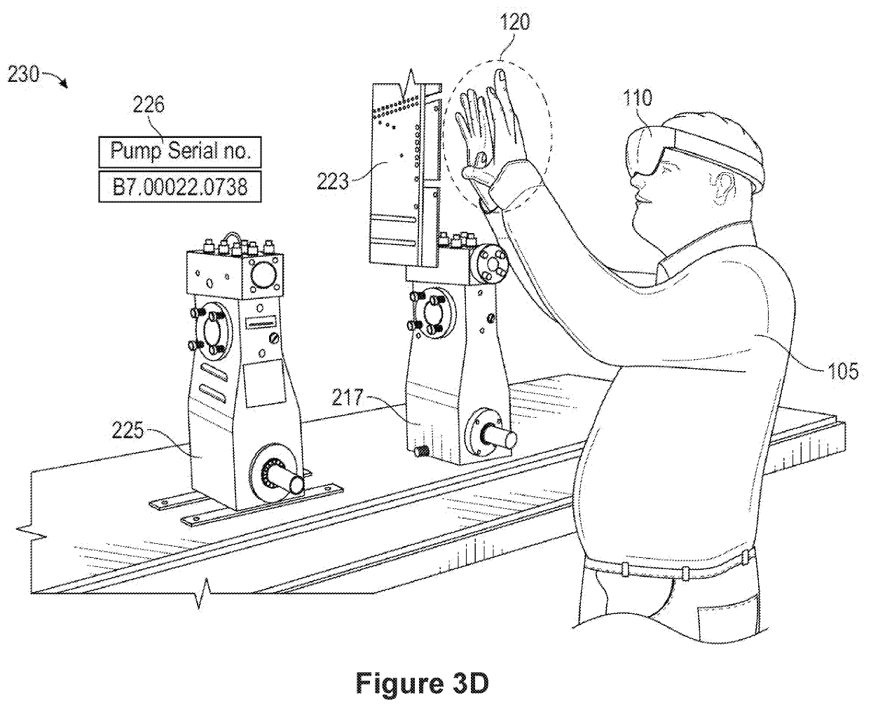

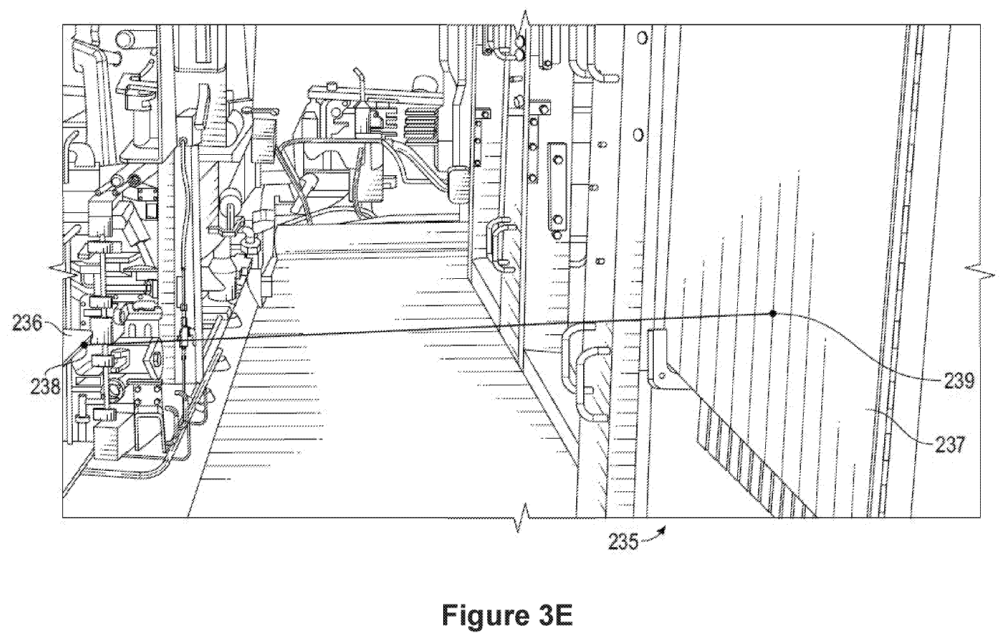

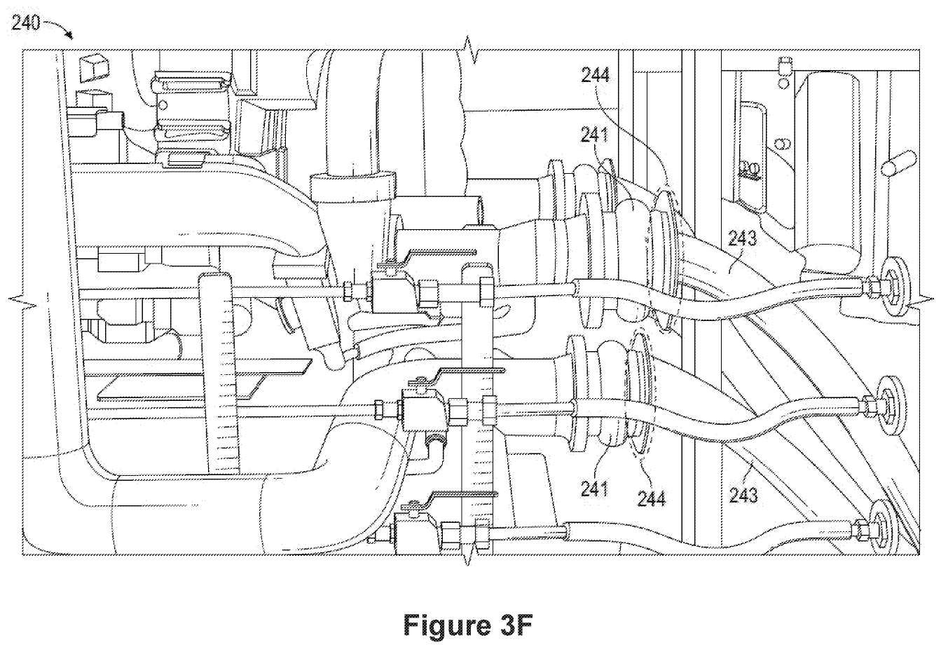

One example of a quality control inspection that can be performed in block 202 of method 200 includes placing a virtual object inside a real object to scrutinize and determine whether the real object fully contains the virtual object (i.e., no portion of the virtual object extends from the real object). In such an example, the user 105 inspects whether the virtual object completely fits in the real object. For example, referring briefly to FIG. 3A, an exemplary scene 205 from an inspection carried out in block 202 of method 200 by the user 105 wearing the head-worn display device 110 is shown. Scene 205 illustrates a real object 207 and a virtual object 210. In the example scene 205 shown in FIG. 3A, the real object 207 is a metal enclosure to house various drilling equipment and connection pipes at a drilling site, and the virtual object 210 is a virtual representation of the drilling equipment and connection pipes to be housed in the real object 207. In other words, in this example, the virtual object 210 is not a virtual representation of the real object 207. Rather, in this example, the virtual object 210 is a virtual representation of object(s) that are supposed to be housed within the real object 207. Thus, the user 105 is able to concurrently see both the metal enclosure (the real object 207) and the virtual representation of the drilling equipment and connection pipes (e.g., virtual object 210) to be housed in the real object. Even though the overall assembly is still at an early stage of manufacturing, the user 105 is able to visualize the virtual object 210 inside the real object 207, thereby allowing the user 105 to preemptively address any perceived errors such as clashes (e.g., overlap or interference between structural elements of the real object 207 and elements of the virtual object 210), access (e.g., whether elements of virtual object 210 will be accessible or block access to other elements stored in the real object 207), as well as foresee modifications that may correct clashes or access issues before an error actually materializes. Any identified errors can be marked and measured with a virtual measuring tape as described in more detail below. The errors and any virtual measurements can be saved in a work control system that can be accessed by the user 105 by performing a gesture 120 such that they may be subsequently addressed.

In the example shown in FIG. 3A, the virtual object 210 is depicted by head-worn display device 110 in a separate box 209. The separate box 209 may overlay a portion of the display screen showing the real object 207 in which the virtual object 210 is to be housed. The user 105 can differentiate between the real object 207 and the virtual object 210 by their perceived transparency. Meaning that, when seen from the head-worn display device 110, the real object 207 may appear opaque and solid, whereas the virtual object 210 within the separate box 209 may appear slightly transparent. In summary, the user 105, while wearing the head-worn display device 110, can concurrently see both real objects (e.g., real object 207) and virtual objects (e.g., virtual object 210), which assists the user 105 in the inspection process.

In some examples, the user 105 may transform his/her frame of reference by moving around the real object (e.g., real object 207) to see if the virtual object (e.g., virtual object 210) is protruding from the real object. In scenarios where the virtual object is not fully contained in the real object, the user may highlight the issue and any virtual measurements thereof in the work control system. In some examples, the user 105 may leave a voice note in the work control system for the issue identified by the user 105.

Another example of a quality control inspection that can be performed in block 202 of method 200 includes comparing a real object to a virtual object that is a virtual representation of the real object. In other words, the virtual object corresponds to the real object being inspected. For example, referring briefly to FIGS. 3B and 3C, exemplary scenes 215, 220 from an inspection carried out in block 202 of method 200 by the user 105 wearing the head-worn display device 110 is shown. In exemplary scenes 215, 220, a real object (e.g., pump) is inspected and compared to a corresponding virtual object. In particular, scene 215 of FIG. 3B shows the user 105 wearing the head-worn display device 100 previously described and performing an inspection, and scene 220 of FIG. 3C shows the view of the user 105 through the head-worn display device 110 while performing the inspection of FIG. 3B.

Referring first to FIG. 3B, the user 105, uses a gesture 120, to select and move a virtual object 217 that corresponds to a real object 225. As shown in FIG. 3C, the user 105 positions the virtual object 217 adjacent the corresponding real object 225 on a horizontal surface 221, such as a table. The user 105 may then visually compare the real object 225 and the virtual object 217 to inspect the real object 225. As shown in FIG. 3C, in addition to a visual comparison and inspection, or as an alternative, the user 105 may access a specification manual related to the real object 225 using a gesture 120 to select the specification manual from the memory 129. The specification manual may appear as a virtual specification 223 displayed on the display screen of the head-worn display device 110. Using gesture(s) 120, the user 105 may scroll through the virtual specification 223 and find relevant information. For example, the user 105 may want to match a serial number of the real object 225 with a serial number of the virtual object 217 (an exemplary serial number is labelled 226). The user 105 may do so by comparing the serial number written on the real object 225 with the serial number associated with the virtual object 217. Since, the virtual object 217 is a virtual representation of the real object 225 in this example, the serial numbers should match. In scenarios where the serial numbers do not match, the user 105 may highlight the issue in the work control system so that it may be subsequently addressed.

Another example of a quality control inspection that can be performed in block 202 of method 200 includes measuring a dimension of a real object or a distance between two real objects using a virtual measuring tape and hand gestures. For example, referring briefly to FIG. 3E, exemplary scene 235 from an inspection carried out in block 202 of method 200 by the user 105 wearing the head-worn display device 110 is shown. In this example, the user 105 may need to inspect a width 236 of a walkway between a first real object 236 and a second real object 237. The user 105 may do so by using a virtual measuring tape. In particular, using gesture(s) 120, the user 105 may point to the starting point 238 for the measurement and then reach to the ending point 239 of the measurement. In the example shown in FIG. 3E, starting point 238 is an exterior of the first real object 236 and ending point 239 is an exterior of the second real object 237 placed directly opposite the first real object 236. The distance between the starting point 238 and ending point 239, in this example, is 4 feet and 6 inches, as measured by the virtual measuring tape. This measurement may be compared with the desired measurement mentioned in the specification manual that can be accessed by the user 105 by performing the gesture 120. The measurements and comparison of the measurements to the desired measurements in the specification manual can be saved in the work control system so that it may be subsequently addressed. In yet other examples, the user 105 may inspect the dimensions of an equipment (or portions thereof) by virtually measuring the desired dimension and then checking the measured dimension against a pre-defined or stored dimension of the corresponding equipment (or portion thereof).

A dimensional quality control inspection can also be performed in block 202 of method 200 by comparing a real object and a virtual object side-by-side. For example, in FIG. 3F, a scene 240 as viewed by the user 105 through the head-worn display device 110 is shown. In scene 240, the user 105 performs a dimensional inspection by placing a virtual object 241 adjacent to a real object 243 to visually observe whether the virtual object 241 connects to the real object 243 at a predetermined, desired connection or tie-in point. Namely, the virtual object 241 is a virtual representation of a real object that is to be coupled to the real object 243 at the tie-in point 244. Dimensional discrepancies between the desired tie in point and the location where the virtual object 241 connects to the real object 243 can be marked and virtually measured with the virtual measuring tape as previously described. Any perceived issues or discrepancies, as well as any measurements of discrepancies, can be saved in the work control system for future reference so that they can be subsequently addressed.

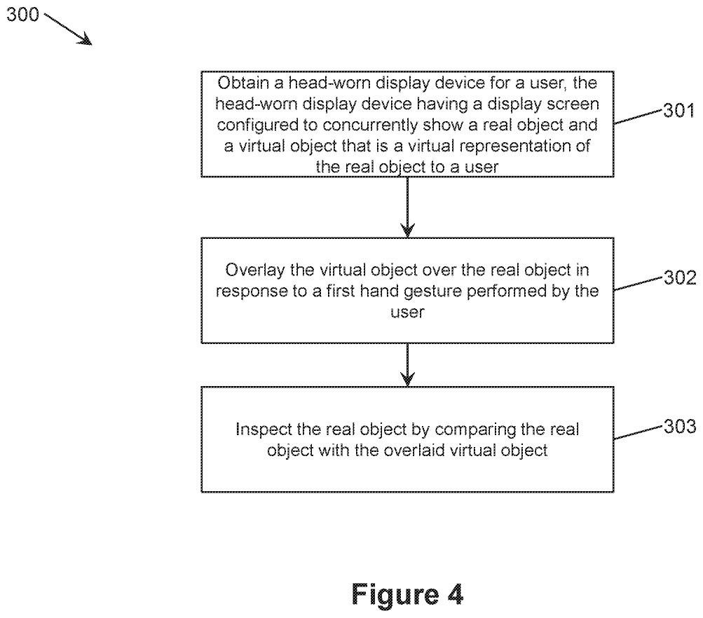

Referring now to FIG. 4, another embodiment of an inspection method 300 for performing an inspection with the system 100 is shown. Method 300 is similar to method 200 previously described with the exception that method 300 is particularly focused on inspections performed by comparing real objects with virtual objects that are virtual representations of the corresponding real objects. In this embodiment, method 300 begins in block 301 that includes obtaining a head-worn display device 110 to be worn by the user 105, the head-worn display device 110 having a display screen 115 configured to concurrently display a real object and a virtual object that is a virtual representation of the real object. Moving now to block 302, method 300 includes overlaying the virtual object over the real object in response to a hand gesture 120 performed by the user 105. Next, the real object is inspected in block 303 by comparing the real object with the overlaid virtual. Examples of some of the quality control inspections that may be performed according to method 300 by the user 105 using the head-worn display device 110 are described herein. The scope of this disclosure, however, is not limited to the exemplary inspections described herein, and other inspections may be performed via block 303 using the system 100.

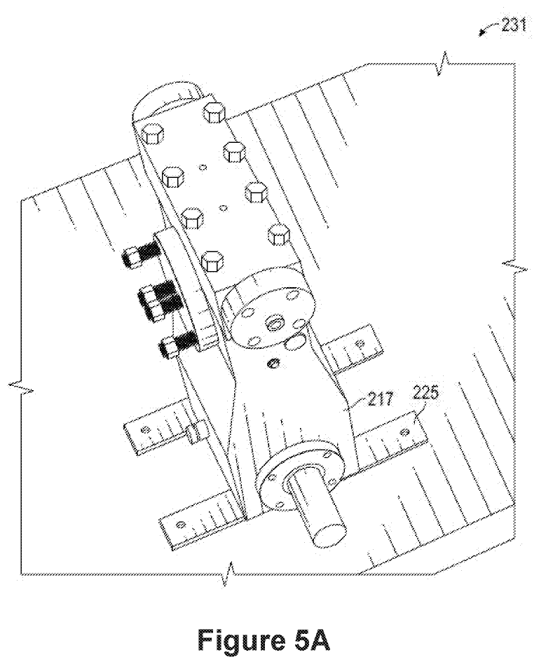

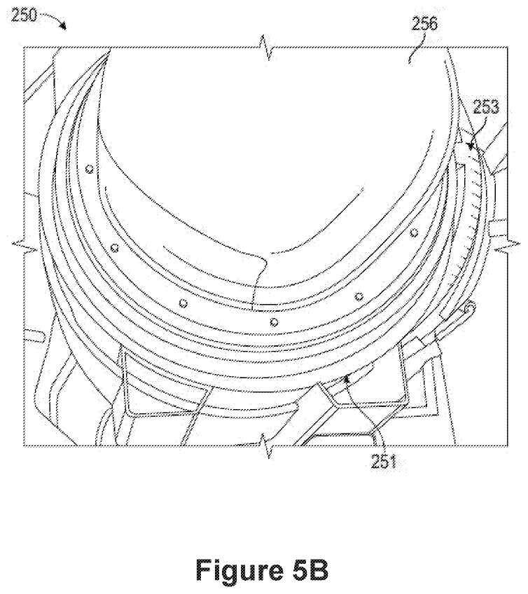

One example of a quality control inspection that can be performed in block 303 of method 300 includes overlaying the virtual object onto the real object to check whether the dimensions of the real object follow the intended specification dimensions. For example, referring now to FIG. 5A, an exemplary scene 231 from an inspection carried out in block 303 of method 300 by the user 105 wearing the head-worn display device 110 is shown. To perform this inspection, the user 105 uses a gesture 120 to overlay a virtual object 217 over a corresponding real object 225. The virtual object 217 is a virtual representation of the real object 225. Next, the user 105 visually checks whether the virtual object 217 fully overlays the real object 225. If the real object 225 is fabricated per the specified dimensions, the real object 225 and the virtual object 217 will exhibit dimensional conformity. If not, then the user 105 would notice any non-conformities and can highlight any such issue(s) in the work control system so that they can be subsequently addressed. Any identified dimensional discrepancies between the real object 225 and the virtual object 217 can be marked and measured with a virtual measuring tape as described above. The dimensional discrepancies and any virtual measurements can be saved in a work control system that can be accessed by the user 105 by performing a gesture 120 such that they may be subsequently addressed.

As yet another example of a quality control inspect that can be performed in block 303 of method 300, the user 105 may perform an inspection to determine errors or defects in a real object by overlaying a virtual object corresponding to the real object onto the real object. For example, in FIG. 5B, a scene 250 as viewed by the user 105 through the head-worn display device 110 previously described while performing an inspection is shown. In scene 250, a virtual object 251 is laid over a corresponding real object 253. After overlaying the virtual object 251 over the real object 253, the user 105 visually inspects the virtual object 251. The real object 253 and the virtual object 251 do not match. Specifically, the virtual object 251 includes a vent cap 256 while the real object 253 does not have a vent cap. The presence of the vent cap 256 is an error or a defect. In some examples, the user 105 may access the work control system to highlight the error or defect.

In the foregoing discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections. Similarly, a device that is coupled between a first component or location and a second component or location may be through a direct connection or through an indirect connection via other devices and connections. An element or feature that is “configured to” perform a task or function may be configured (e.g., programmed or structurally designed) at a time of manufacturing by a manufacturer to perform the function and/or may be configurable (or re-configurable) by a user after manufacturing to perform the function and/or other additional or alternative functions such as slopes of pipes or clearance in front of a certain panel or width of aisles which could be required by local regulations. The configuring may be through firmware and/or software programming of the device, through a construction and/or layout of hardware components and interconnections of the device, or a combination thereof. Additionally, uses of the phrases “ground” or similar in the foregoing discussion are intended to include a chassis ground, an Earth ground, a floating ground, a virtual ground, a digital ground, a common ground, and/or any other form of ground connection applicable to, or suitable for, the teachings of the present disclosure. Unless otherwise stated, “about,” “approximately,” or “substantially” preceding a value means+/−10 percent of the stated value.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

Certain terms are used throughout the foregoing description and following claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

What is claimed is:

1. A method for performing an inspection, the method comprising:
(a) concurrently viewing a real object through a display screen of a head-worn display device worn by a user and a virtual object projected on the display screen of the head-worn display device;
(b) comparing the virtual object to the real object; and
(c) generating an inspection result in response to the comparison.

2. The method of claim 1, wherein comparing the virtual object to the real object comprises placing the virtual object inside the real object to determine whether the real object fully contains the virtual object therein.

3. The method of claim 2, wherein the real object is a housing to be deployed on a drilling rig and the virtual object is a virtual representation of one or more structures to be placed inside the housing.

4. The method of claim 1, wherein the virtual object is a virtual representation of the real object.

5. The method of claim 4, wherein comparing the virtual object to the real object comprises:
overlaying the virtual object onto the real object using a hand gesture by the user; and
visually determining whether the virtual object completely overlays the real object.

6. The method of claim 4, further comprising:
examining a first number that is associated with the real object with a second number that is associated with the virtual object.

7. The method of claim 6, wherein the first number is a serial number on the real object and the second number is a serial number of the virtual object.

8. The method of claim 1, wherein comparing the virtual object to the real object comprises:
measuring a dimension of a portion of the real object using a hand gesture; and
comparing the dimension with a stored dimension value of the portion.

9. The method of claim 1, wherein comparing the virtual object to the real object comprises:
positioning the virtual object adjacent to the real object to visually determine whether the virtual object ties into the real object at a desired tie in point, wherein the virtual object is a virtual representation of another real object that is to be coupled to the real object at the desired tie in point.

10. The method of claim 1, wherein the display screen is partially-transparent or transparent.

11. A method for performing a quality control inspection, the method comprising:
(a) concurrently viewing a real object through a display screen of a head-worn display device worn by a user and a virtual object displayed on the display screen, wherein the virtual object is a virtual representation of the real object;
(b) overlaying the virtual object over the real object in response to a first-hand gesture performed by the user;
(c) inspecting the real object while the virtual object is overlaying the real object.

12. The method of claim 11, wherein inspecting the real object while the virtual object is overlaying the real object comprises visually inspecting whether the virtual object completely overlays the real object.

13. The method of claim 12, further comprising:
virtually marking a discrepancy between the virtual object and the real object.

14. The method of claim 13, measuring a size of the discrepancy between the real object and the virtual object with a virtual measuring tape.

15. The method of claim 1, wherein the display screen is semi-transparent or transparent.
